(19) United States
(12) Patent Application Publication
(10) Pub. No.: US 2019/0007539 A1
(43) Pub. Date: Jan. 3, 2019

(54) TRANSFERRABLE BODY-WORN SYSTEM AND METHOD FOR HANDS-FREE DEVICE CONTROL

(71) Applicant: Stephen P. Forte, Beverly Hills, CA (US)

(72) Inventor: Stephen P. Forte, Beverly Hills, CA (US)

(21) Appl. No.: 15/640,073

(22) Filed: Jun. 30, 2017

(51) Int. Cl. H04M 1/60; H04W 4/10; G06F 3/01; H04M 1/725

(52) U.S. Cl. CPC H04M 1/6041; H04W 4/10; H04M 1/7253; G06F 3/017; G06F 3/011

(57) ABSTRACT

A system is provided comprising a portable electronic module including connectivity with at least one sensor separate from the device and associated with a user of the device, connectivity with at least one communication device associated with the user, and an application, that when executed on the portable electronic module, receives a first signal from the at least one sensor, the first signal requesting wake-up of the at least one communication device, and activates the at least one communication device based on receipt of the first signal, wherein the portable electronic device is attached to wearable items comprising at least one of a garment, an item of headgear, item of neckwear or helmet chin strap worn by the user.

### CROSS REFERENCE TO RELATED APPLICATIONS

None.

### FIELD OF THE DISCLOSURE

The present disclosure is in the field of wireless devices. More particularly, the present disclosure is in the technical field of hands-free electronic device activation and control based on based on messages received from body-worn sensors.

### BACKGROUND OF THE DISCLOSURE

Persons engaging in intense sports or other physical activities may wish to activate, use and control communications and other devices. For reasons of safety, convenience and economy, the user may be unwilling or unable to manually take hold of a communications device. A person engaging in rock climbing, parachuting, hang gliding, or racecar driving, for example, may be safer when both hands are available. A surgeon, pilot, or member of the military may need both hands and full attention to deal with a rapidly developing and tense situation. Emergency responders, for example law enforcement officers, firefighters, and paramedics may be burdened with heavy equipment in hostile and dangerous environments. Such responders may need to communicate instantly without having to manually activate devices.

### SUMMARY OF THE DISCLOSURE

Systems and methods described herein provide a removable body-worn electronic module that processes messages received from a plurality of body sensors. The messages sent by the sensors are caused by intentional user actions, for example movements or sounds, or unintentional user actions such as an increased heart rate. Based on the received messages, the electronic module causes body-worn communication and other devices to wake up and operate accordingly, for example to initiate a desired hands-free outgoing call or initiate a push-to-talk conversation.

The body-worn module may be sewn into or attached to garments, headgear, or other wearable items. The module may be removed and attached to other wearable items where it may then receive signals from the same or different body sensors and activate and control the same or other body-worn communications devices.

### BRIEF DESCRIPTION OF THE DRAWINGS

FIG. 1 is a block diagram of a transferrable body-worn system for hands-free device control in accordance with an embodiment of the present disclosure.

### DETAILED DESCRIPTION OF THE INVENTION

A user of the electronic module provided herein causes body-attached sensors through user sounds, movements, or other actions to send various messages to the module. The module in turn causes communication devices also attached to the user to activate and operate in accordance with instructions associated with the messages from the sensors. This process may all take place in a fully hands-free manner for the user, promoting safety and convenience

The module provided herein is programmable to recognize and execute on various messages received from sensors physically attached to the user. The sensors may be wearable accelerometers, contact microphones, bone conductors, heart rate monitors or other devices that detect user actions including movements, sounds, and vibrations. Based on a message received from a sensor prompted by user action, the module may wake up a communication device also attached to the user and cause the device to initiate an outgoing communication, for example.

The user, when rock climbing for example, may cause a communication to be established with another climber or ground personnel without ever having to use his/her hands. The rock climber may make a specific movement or sound that is detected by a sensor attached to the climber's body, for example around the climber's neck and proximate the climber's throat. The sensor, which may be configured to detect and respond to more than one type of movement of sound, sends a message specifically associated with the movement or sound wirelessly or via wired means to the module attached to the user's garment.

The message sent by the sensor contains coding associated with a certain request of the user. The message is specific to the user's movement or sound and the contained coding is specific to an action that the user wishes the electronic module to carry out with a communication device also attached to the user. The user, while perhaps scaling a very steep rock incline, may wish one of his/her attached communication device to contact a fellow climber and/or someone on the ground. Based on the message from the sensor, caused by the user movement or sound, the electronic module causes the communication device to make such desired contact.

The module also contains functionality to cancel out noise, for example the noise of high winds that may be buffeting the rock climber. Aircraft carrier deck personnel may wish to cancel out jet engine noise during missions.

The module snaps into separate housing such as an enclosure on a ski mask or in a motorcycle helmet or other protective gear. A neoprene pocket on a sporting garment may hold the module. As noted, a neck piece of a throat microphone may also secure the module.

In embodiments, a small docking station or plug connection may be provided for the electronic module to physically connect with and for the sensors and communication devices to attach wirelessly and/or via wired connection. The small docking station may remain semi-permanently attached to a garment or body worn item or may be removable and portable in the manner of the electronic module.

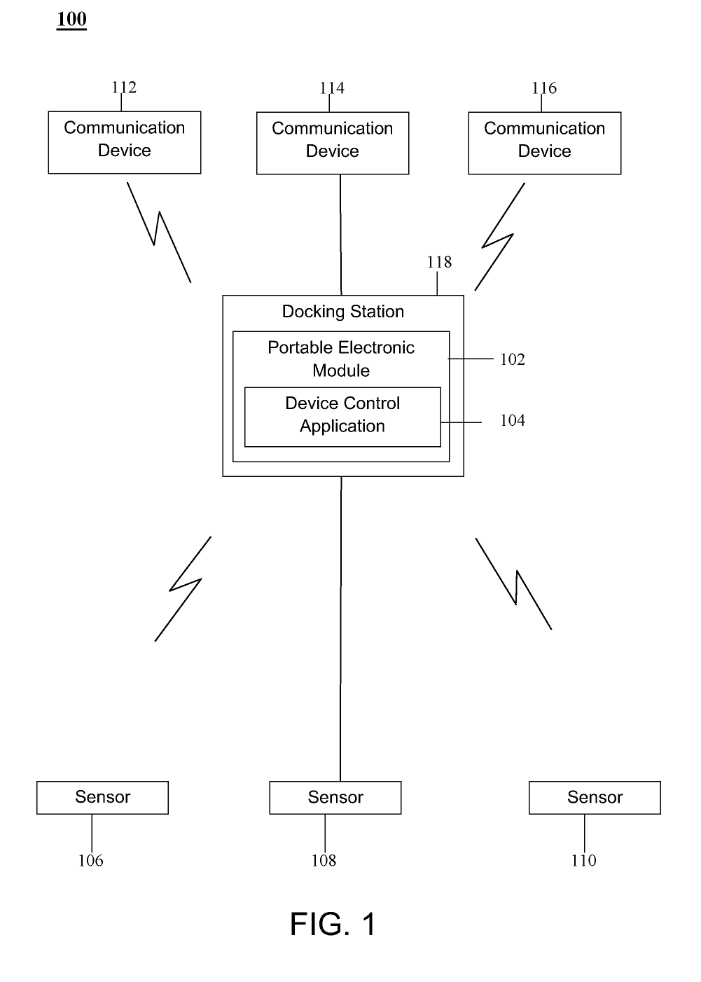

Turning to the figures, FIG. 1 is a block diagram of a transferrable body-worn system for hands-free device control in accordance with an embodiment of the present disclosure. FIG. 1 depicts components of a system 100 provided herein. System 100 comprises a portable electronic module 102, a device control application 104, sensors 106, 108, 110, communication devices 112, 114, 116, and a docking station 118.

For brevity purposes, the portable electronic module 102 and the device control application 104 may be referred to respectively as the module 102 and the application 104. Disclosures about any of the sensors 106, 108, 110 apply to all sensors 106, 108, 110 unless specifically stated otherwise. Disclosures about any of the communication devices 112, 114, 116 apply to all communication devices 112, 114, 116 unless specifically stated otherwise.

The module 102 is a light electronic device that is wearable such that it may be attached to or contained by a garment worn by the user. The module 102 may be sewn into the garment, attached to the garment via a Velcro or similar attachment, or may be held within a pocket of the garment. While the term “garment” in embodiments refers primarily to items of clothing worn by a user, for example a ski jacket or parka while skiing, the term garment as used herein may also include headgear such as hats and helmets as well as other wearable items such as glasses, scarves, gloves, and footwear.

The module 102 is readily transferrable from a first garment to a second garment worn by the user. In the case of cloth garments, the module 102 does not require configuration as regards the specific garment to which the module 102 may be attached at a given time to function as taught herein. When the module 102 is attached to a helmet, some physical configuration may be necessary to accommodate the module.

The module 102 contains hardware and software components promoting wired and wireless connectivity to sensors 106, 108, 110 and communication devices 112, 114, 116. Connectivity to these separate components by the module 102 may be via at least one of wired and wireless connection.

The application 104 executes at least on the module 102 and receives messages from the sensors 106, 108, 110. The application 104 is configured to identify the sensor 106 from which a message is received. The application 104 further determines action requested by the message which may be to “wake up” or otherwise activate at least one communication device 112, 114, 116 also attached to the user in some manner. The application 104 may make such determination based on instruction contained in the message from the sensor 106, based on instruction stored in the module 102, and/or instruction stored elsewhere, including locations separate from the user.

The application 104 contacts the communication device 112 associated with the message from the sensor 106. The application 104 causes the communication device 112 to activate and establish a session with another device or execute whatever step is associated with the message from the sensor 106, the message having been prompted by the user's movement or sound.

The sensor 106 may be a wearable accelerometer, a contact microphone, a bone conduction device, or other device that detects user movement, sound, or other action. The sensor 106 is attached to the user's body in some manner. The sensor 106 may be waterproof.

The communication device 112 may be a communications unit that establishes wireless voice, text and other types of contact with entities separate from the user. While the component name “communication device” implies that the functionality of the communication device 112 is limited to or is primarily communication, the component name is provided for brevity and discussion purposes. Communication device 112 may perform actions other than communications, for example controlling temperature or humidity inside a suit worn by the user.

As noted, the module 102 is detachable from a first garment and transferrable to a second garment. The user may maintain the same or different sensors 106, 108, 110 and may use the same or different communication devices 112, 114, 116 with the second garment. The application 104 is programmable such that it recognizes when the module 102 has been moved and connected with different sensors 106, 108, 110 and/or different communication devices 112, 114, 116 than previously. In embodiments, the module 102 may contact devices (not shown in FIG. 1) distant from the user to access configuration information for use in functioning with various sensors 106, 108, 110 and communication devices 112, 114, 116.

The module 102 may snap into a neck piece of a throat microphone functioning as a sensor 106 and/or in another capacity. The throat microphone may detect physical movements in addition to sound. The module 102 may be magnetically placed on a base station for recharging. The module 102 may be recharged in other manners.

The docking station 118 may be an optional component that the module 102 may be plugged into or otherwise attached to. The docking station 118 may in some embodiments remain semi-permanently attached to a garment with the module 102 attached and detached from the docking station as the user wears the garment and then wears a different garment that may have its own semi-permanent docking station 118. In an embodiment, when one or both of the sensors 106 and the communication device 112 are not wireless and instead require wired connections to the module 102, these components may connect to the docking station 118 via wired connection and thus permit the module 102 to be easily attached to and detached from the docking station without disrupting any such wired connections.

Systems described immediately above may comprise the docking station 118, at least one sensor 106, at least one communication device 112, the module 102, and the application 104. The module 102 is coupled to the docking station 118. The application 104 receives a first signal from the at least one sensor 106 via the docking station 118, the first signal requesting wake-up of the at least one communication device 112. The application 104 activates the at least one communication device 112 based on receipt of the first signal. At least one of the docking station 118 and the module 102 is attached to wearable items comprising at least one of a garment, an item of headgear, and an item of neckwear worn by the user. At least one of the docking station 118 and the module 102 is detachable from the wearable items and transferrable to additional wearable items.

In an embodiment, the module 102 and application 104 executing thereon may provide for push-to-talk functionality on an effective hands free basis. When the user engages in a push-to-talk session via the communication device 112, the sensor 106 and the application 104 may be configured accordingly. When, for example, the user during the push-to-talk conversation wishes to speak, the components may be configured as provided herein such that by making a particular movement or sound with a sensor 106, the sensor 106 may send a particular signal to the module 102 and application 104. The application 104 receives and recognizes the signal as indicating that the user wishes to speak in the push-to-talk conversation via the communication device 112. The application 104 then transmits an instruction to the communication device 112 which causes the communication device 112 to effectively activate talk functionality for the user. A beep or other audible sound may be played for the user which is an indication to the user that he or she may speak in the push-to-talk session.

In an embodiment, the module 102 and application 104 executing thereon may provide for noise cancellation in various situations. For example, the user deploying the components and interactions as provided herein may be participating in a conference call. The application 104 may be configured to cancel out background noise originating from user when he/she is not talking.

What is claimed is:

1. A system comprising:
a portable electronic device comprising:
connectivity with at least one sensor separate from the device and associated with a user of the device;
connectivity with at least one communication device associated with the user;
an application, that when executed on the portable electronic device:
receives a first signal from the at least one sensor, the first signal requesting wake-up of the at least one communication device, and
activates the at least one communication device based on receipt of the first signal,
wherein the portable electronic device is attached to wearable items comprising at least one of a garment, an item of headgear, an item of neckwear or helmet chin strap worn by the user.

2. The system of claim 1, wherein the portable electronic device is detachable from the wearable items and transferrable to additional wearable items.

3. The system of claim 2, wherein when the portable electronic device is transferred to the additional wearable items, the portable electronic device connects interchangeably with at least one of the previous sensors and previous communication devices and with additional sensors and communication devices.

4. The system of claim 1, wherein the first signal is generated at the at least one sensor by user actions comprising at least one of sound, a vibration, and a physical movement, and via biometrically generated activity.

5. The system of claim 4, wherein the portable electronic device receives a plurality of types of signals from the at least one sensor generated by the plurality of user actions, each of the plurality of types of signals indicating an action to be performed by the portable electronic device with reference to the at least one communication device.

6. The system of claim 1, wherein the application constantly monitors for signals generated by the at least one sensor and create wake-up states for the at least one communication device.

7. The system of claim 1, wherein the at least one sensor and the at least one communication device communicate with the portable electronic device at least one of wirelessly and via wired connection.

8. The system of claim 1, wherein the at least one sensor is a bone conduction microphone, an accelerometer, an ear canal device, a heart rate monitor, or a contact microphone.

9. The system of claim 1, wherein the portable electronic device is coupled to a body attached bone conduction microphone or accelerometer.

10. The system of claim 1, wherein the at least one communication device is a voice communication device comprising a Bluetooth wearable combination of microphones and speakers with wireless connection to a smartphone.

11. The system of claim 1, wherein the portable electronic device detaches from the at least one of the wearable items thus allowing for connection to a separate power adapter or a base station for charging.

12. The system of claim 1, wherein the portable electronic device provides for noise cancellation.

13. A system comprising:
portable electronic module comprising:
a processor;
a memory; and
an application stored in the memory that when executed on the processor:
receives a signal from a body-worn sensor,
determines that the signal is directed to a body-worn communication device,
determines that the signal indicates an intention to speak during a push-to-talk session,
determines that the communication device is presently engaged in the push-to-talk session,
activates talk functionality in the push-to-talk session, and
causes the communication device to emit a sound audible to a user of the sensor and communication device, the sound indicating availability of the talk functionality.

14. The system of claim 13, wherein the application effectively enables push-to-talk functionality in a hands-free manner.

15. The system of claim 13, wherein the module is attachable to wearable items of the user comprising at least one of a garment, an item of headgear, or an item of neckwear worn by the user.

16. The system of claim 13, wherein the signal is generated at the sensor by user actions comprising at least one of sound, a vibration, and a physical movement, and via biometrically generated activity.

17. A system comprising:
a portable electronic module comprising:
a processor;
a memory; and
an application stored in the memory that when executed on the processor:
causes a first communication device to join a conference call attended by at least a second communication device,
detects whether the device users are speaking based on signals from sensors, then enables the microphones on the device when speech is detected, and
during at least one subsequent period during which a user of the communication device is determined to be not speaking, disables the microphone and cancels out the background noise to other parties.

18. The system of claim 17, wherein the background noise comprises at least one of wind, background voices, music, and mechanical noise.

19. The system of claim 17, wherein the portable electronic module and the first communication device are attached to items wearable by the user of the first communication device.

20. The system of claim 17, wherein the portable electronic module causes the first communication device to join the conference call based on at least one signal received from a sensor worn by the user of the first communication device.
